(19) United States
(12) Patent Application Publication
(10) Pub. No.: US 2005/0251372 A1
(43) Pub. Date: Nov. 10, 2005

(54) Computer product, design aiding method, and design aiding apparatus

(75) Inventors: Kazuhiro Takeuchi, Shizuoka (JP); Masahiro Nagakura, Shizuoka (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/933,437

(22) Filed: Sep. 3, 2004

(30) Foreign Application Priority Data
May 7, 2004 (JP) 2004-139065

(51) Int. Cl. G06F 17/50

(52) U.S. Cl. 703/1

(57) ABSTRACT

An inheritance definition object processor creates an inheritance definition object, an attribute processor creates attributes, and the created inheritance definition object and the attributes are added to a working axis created by a shape creating/editing unit. When creating a shaft from the working axis, the shape creating/editing unit transfers the attributes to the corresponding parts of the shaft, based on the inheritance definition object added to the working axis.

### BACKGROUND OF THE INVENTION

1) Field of the Invention

The present invention relates to a design aiding program and a design aiding method that aid in designing parts employing a top-down approach. More particularly, the present invention relates to a design aiding program and a design method that precludes lapse of design intent of a designer.

2) Description of the Related Art

In recent years, designing of parts constituting various products is being carried out with the aid of 3 Dimension Computer Aided Design (3D CAD). One of the approaches in designing of parts involves starting with an abstract shape and gradually transforming it into a detailed tangible shape. This approach of designing is called a top-down designing.

When designing the parts using the top-down approach, the designer usually decides in the initial stage, based on the functional requirements, what attributes (such as, surface roughness) should be added to the parts when they are created.

The designer either appends information pertaining to the attributes to an abstract element (hereinafter, “reference element”) in the initial stage or creates another design drawing apart from a CAD drawing. Once the final part is created, the user of the 3D CAD program, manually adds the attributes to the part by referring to information pertaining to the attribute appended to the reference element or to the design drawing. Japanese Patent Laid-Open Publication No. 2003-330972 discloses a user-friendly technology enabling addition of attributes to data created in a computer-aided designing (CAD) device.

However, in the conventional technology, the attributes that the designer intended sometimes may not get added to the final part due to human error, etc.

Further, the user has to ascertain the contents of each attribute one by one, and add the attributes to the final part based on the contents. This exercise generally puts a huge load to the user if the number of attributes to be added to the reference element is large.

### SUMMARY OF THE INVENTION

It is an object of the present invention to solve at least the problems in the conventional technology.

A computer program according to an aspect of the present invention contains instructions which when executed on a computer cause the computer to perform obtaining an attribute and identification information that identifies the attribute, and a definition object that has in a correlated form each of a plural elements constituting a tangible shape element and the identification information of the tangible shape element, that are added to a reference element; and passing on the attribute obtained to a relevant element of the tangible shape element. The reference element is an element of a part in an initial stage in a top-down approach, and the tangible shape element is a tangible form of the reference element.

A computer program according to another aspect of the present invention contains instructions which when executed on a computer cause the computer to perform obtaining from a storage device an attribute and identification information that identifies the attribute, and a definition object that has in a correlated form each of a plural elements constituting a tangible shape element and the identification information of the tangible shape element, that are added to a reference element; and passing on the attribute obtained to a relevant element of the tangible shape element. The reference element is an element of the part in an initial stage in the top-down approach, and the tangible shape element is a tangible form of the reference element.

A design aiding method according to still another aspect of the present invention includes obtaining an attribute and identification information that identifies the attribute, and a definition object that has in a correlated form each of a plural elements constituting a tangible shape element and the identification information of the tangible shape element, that are added to a reference element; and passing on the attribute obtained to a relevant element of the tangible shape element. The reference element is an element of a part in an initial stage in a top-down approach, and the tangible shape element is a tangible form of the reference element.

A computer-readable recording medium according to still another aspect of the present invention includes stores the above computer program.

A design aiding apparatus according to still another aspect of the present invention includes an obtaining unit that obtains an attribute and identification information that identifies the attribute, and a definition object that has in a correlated form each of a plural elements constituting a tangible shape element and the identification information of the tangible shape element, that are added to a reference element; and a passing unit that passes on the attribute obtained to a relevant element of the tangible shape element. The reference element is an element of a part in an initial stage in a top-down approach, and the tangible shape element is a tangible form of the reference element.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a concept drawing of design aiding according to a first embodiment of the present invention;

FIG. 2 is a functional block diagram of a design aiding device according to the first embodiment;

FIG. 3 is an example of a data structure of a working axis before shaft creation according to the first embodiment;

FIG. 4 is an example of a data structure of a shaft after shaft creation;

FIG. 5 is a flowchart of a process preceding shaft creation according to the first embodiment;

FIG. 6 is a flowchart of a shaft creation process according to the first embodiment;

FIG. 7 is a concept drawing of a design aid according to a second embodiment of the present invention;

FIG. 8 is a functional block diagram of a design aiding device according to the second embodiment;

FIG. 9 is an example of a data structure of an inheritance definition object and attributes before shaft creation according to the second embodiment;

FIG. 10 is a flowchart of a process preceding shaft creation according to the second embodiment;

FIG. 11 is a flowchart of a shaft creation process according to the second embodiment;

FIG. 12 is a computer system that executes a design aiding program according to both the first and the second embodiments of the present invention; and

FIG. 13 is a functional block diagram of a main unit shown in FIG. 12.

### DETAILED DESCRIPTION

Exemplary embodiments of a computer product, a design aiding method, and a design aiding apparatus according to the present invention are explained next with reference to the accompanying drawings. In these embodiments, a design aiding device is made of physically independent units that realize various functions. However, the present invention can embody a design aiding program that realizes various functions by means of software.

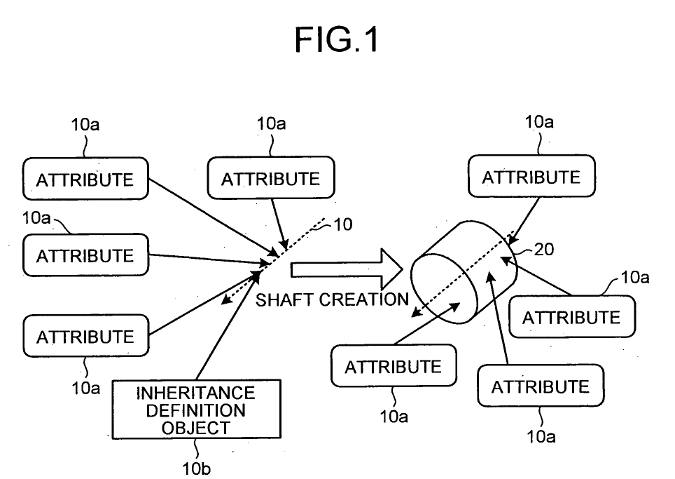

A concept of design aiding according to the present embodiment of the present invention is explained. FIG. 1 is a concept drawing of the design aiding according to the present embodiment. The design aiding involves adding beforehand a plurality of attributes 10a and an inheritance definition object 10b to a reference element 10 (a working axis in the first embodiment) that represents a shape in the initial stage of a top-down designing (a designing approach that starts with an abstract shape and transforms it into a detailed tangible shape).

“Attribute” refers to information pertaining to roughness of a surface, the degree of roughness, etc. which the tangible shape (a shaft in the present embodiment) inherits when it is created. “Inheritance definition object” refers to information that indicates which parts of the tangible shape created in this manner inherits the attributes added to the reference element.

In other words, when a shaft 20 is created, based on the inheritance definition object 10b, the attributes 10a that are added beforehand to the working axis 10 are automatically inherited by each element (side face, plane face, etc.) of the shaft 20. Thus, the automatic inheritance of the attributes 10a by the shaft 20 reduces the load on the user and precludes lapse of design intent due to human error in the initial stage of designing.

It is explained here that the shaft 20 is created from the working axis 10, which is the reference element, and the shaft 20 inherits the attributes 10a. However, attributes can be added to other reference elements, and tangible shapes, inheriting the added attributes at the appropriate parts, can be obtained.

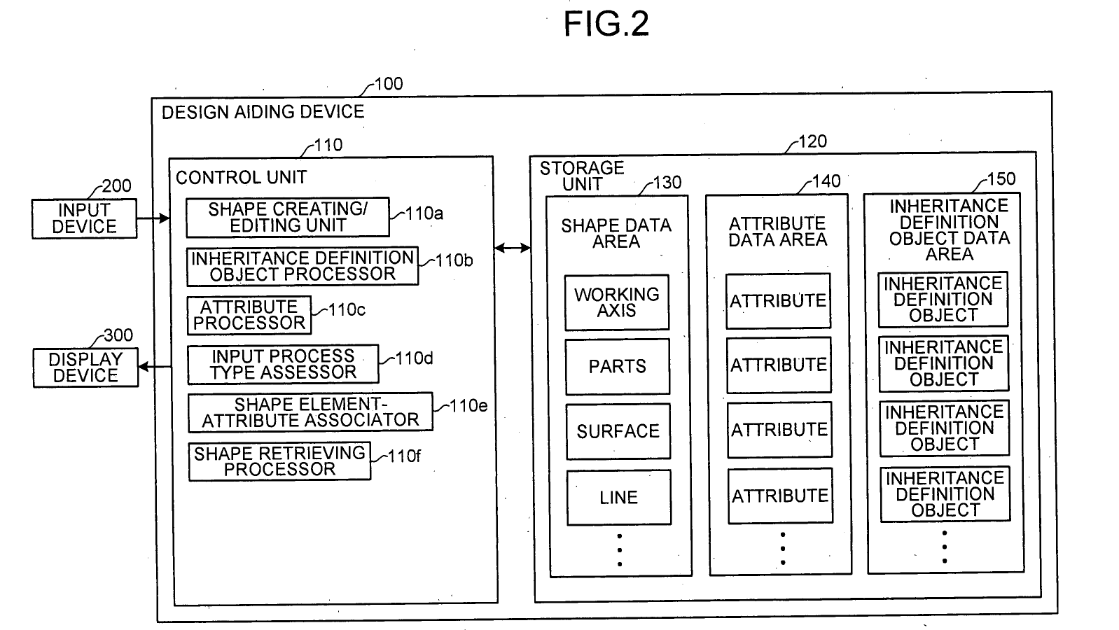

FIG. 2 is a functional block diagram of a design aiding device 100 according to the first embodiment. The design aiding device 100 is connected to an input device 200 such as a keyboard, a mouse, etc., and a display device 300 such as a display.

The design aiding device 100 includes a control unit 110 and a storage unit 120. The control unit 110 includes a shape creating/editing unit 110a, an inheritance definition object processor 110b, an attribute processor 110c, an input process type assessor 110d, a shape element-attribute associator 110e, and a shape retrieving processor 110f.

The shape creating/editing unit 110a receives from the input device 200 information pertaining to the reference element, creates the reference element (the working axis in the present embodiment) based on information pertaining to the reference element, and stores the created working axis in the storage unit 120.

Further, the shape creating/editing unit 110a receives from the input device 200 an instruction to create a tangible shape from the reference element, and converts the specified reference element to its tangible shape (to a shaft in the first embodiment), and stores the created shaft in the storage unit 120.

The inheritance definition object processor 110b receives from the input device 200 information pertaining to the inheritance definition object and information pertaining to the reference element to which the inheritance definition object belongs. Based on the received information, the inheritance definition object processor 110b creates the inheritance definition object, and stores, in a correlated form, the created inheritance definition object and its corresponding reference element in the storage unit 120. Thus, in the first embodiment, the inheritance definition object processor 110b stores, in a correlated form, the working axis and the inheritance definition object corresponding to the working axis in the storage unit 120.

Though a detailed explanation is omitted in the first embodiment, the inheritance definition object processor 110b also creates a default inheritance definition object. The default inheritance definition object includes information pertaining to the destination of the attributes of specific reference elements. In other words, when the tangible shape is created from the reference element, based on the default inheritance definition object, the attributes can be added to the elements of the tangible shape even if the inheritance definition object is not added to the reference element.

The attribute processor 110c receives from the input device 200 information pertaining to the attributes and information pertaining to the reference element to which the attribute belongs. Based on the received information, the attribute processor 110c creates the attribute, and stores in a correlated form the created attributes and their corresponding reference element in the storage unit 120. Thus, in the first embodiment, the attribute processor 110c stores, in a correlated form, the working axis and the elements corresponding to the working axis in the storage unit 120.

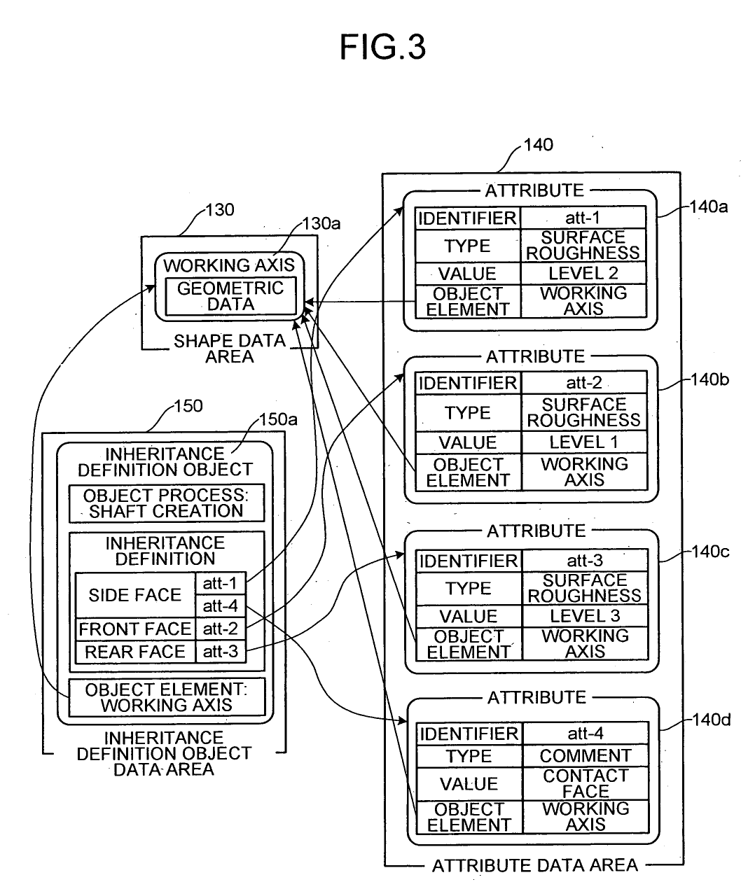

FIG. 3 is an example of a data structure of the working axis before the shaft creation. Geometric data of a working axis 130a, which is the reference element, is stored in a shape data area 130. The geometric data of the working axis 130a is correlated with attributes 140a through 140d stored in an attribute data area 140 and an inheritance definition object 150a stored in an inheritance definition object data area 150.

Each of the attributes 140a through 140d includes “Identifier”, “Type”, “Value”, and “Object element”. “Identifier” stores information that identifies each of the attributes 140a through 140d. For instance, the attribute 140a is identified by an identifier “att-1”, the attribute 140b is identified by an identifier “att-2”, the attribute 140c is identified by an identifier “att-3”, and the attribute 140d is identified by an identifier “att-4”.

“Type” indicates the type of attribute, “Value” indicates the value for the type of attributes, and “Object element” indicates the reference element to which the attribute is added.

To explain sequentially the data structure of all the attributes 140a through 140d, for the attribute 140a, the identifier is “att-1”, the type is “surface roughness”, the value is “level 2”, and the object element is “working axis”.

For the attribute 140b, the identifier is “att-2”, the type is “surface roughness”, the value is “level 1”, and the object element is “working axis”. For the attribute 140c, the identifier is “att-3”, the type is “surface roughness”, the value is “level 3”, and the object element is “working axis”. For the attribute 140d, the identifier is “att-4”, the type is “comment”, the value is “contact face”, and the object element is “working axis”.

The inheritance definition object 150a includes “Object process”, “Inheritance definition”, and “Object element”. “Object process” indicates a process of the object reference element to which the inheritance definition should be applied. Since the object process of the inheritance definition object 150a is “shaft creation”, the inheritance definition object 150a is applied when the shaft is created from the working axis 130a.

“Inheritance definition” indicates which attribute is to be transferred to which part of the tangible shape (the shaft in the first embodiment). To be more specific, the inheritance definition of the inheritance definition object 150a indicates that the attributes 140a and 140d identified by the identifiers “att-1” and “att-4” are transferred to the “side face” of the shaft, the attribute 140b identified by the identifier “att-2” is transferred to the “front face” of the shaft, and the attribute 140c identified by the identifier “att-3” is transferred to the “rear face” of the shaft.

“Object element” refers to the reference element to which the inheritance definition object 150a is added. Since the object element of the inheritance definition object 150a is the “working axis”, it indicates that the inheritance definition object 150a is added to the working axis 130a.

The input process type assessor 110d checks the information received from the input device 200. If the input process type assessor 110d determines that an instruction to create a tangible shape (in the first embodiment, an instruction to create the shaft from the working axis) is received from the input device 200 by the shape creating/editing unit 110a, the input process type assessor 110d notifies the fact to the shape element-attribute associator 110e.

Upon receiving the information pertaining to the transfer of the instruction to create a shaft from the input process type assessor 110d to the shape creating/editing unit 110a, the shape element-attribute associator 110e transfers, based on the inheritance definition object 150a, the attributes added to the working axis to the corresponding parts of the created shaft.

The shape element-attribute associator 110e uses the shape retrieving processor 110f for transferring the attributes to the created shaft. The shape retrieving processor 110f retrieves the shape of the created shaft and notifies the shape element-attribute associator 110e information, such as which is the side face of the shaft or which is the front face of the shaft, etc., which is essential for transferring the attributes.

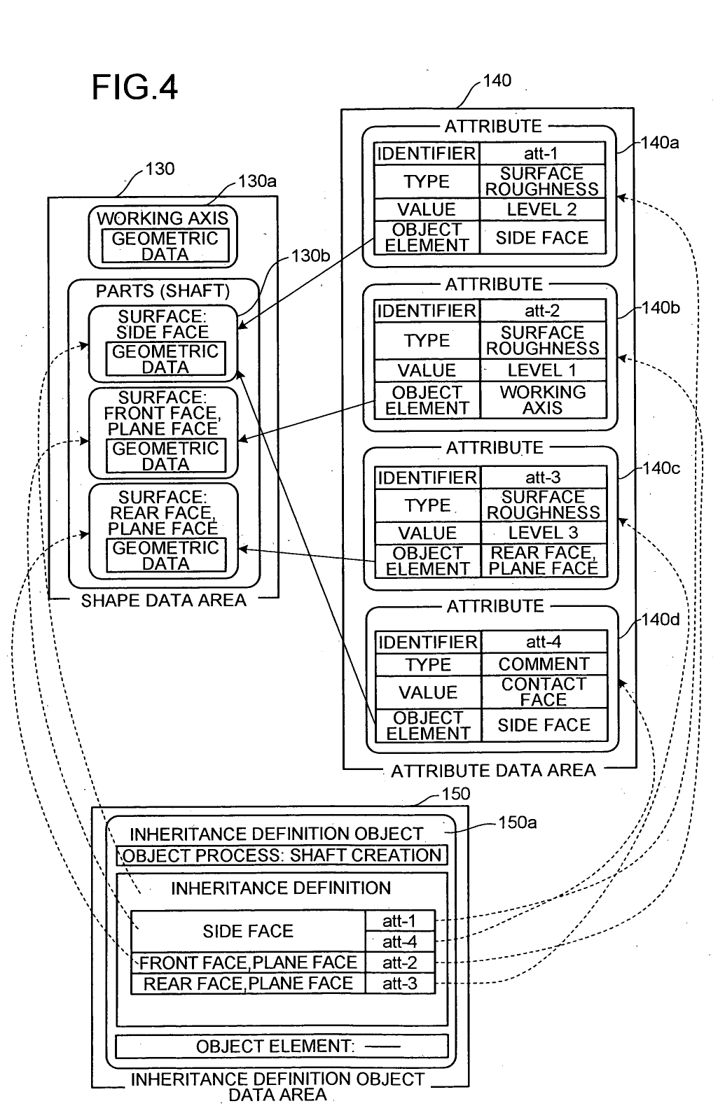

FIG. 4 is an example of the data structure of the shaft after its creation. The shape element-attribute associator 110e adds the attributes 140a through 140d to the geometric data of the working axis 130a and transfers the attributes 140a through 140d to the geometric data (the geometric data of the side face, the front face, and the rear face) of each part of the shaft 130b corresponding to the inheritance definition object 150a.

To be more specific, the shape element-attribute associator 110e transfers the attributes 140a and 140d to the geometric data of the side face, the attribute 140b to the geometric data of the front face, and the attribute 140c to the geometric data of the rear face.

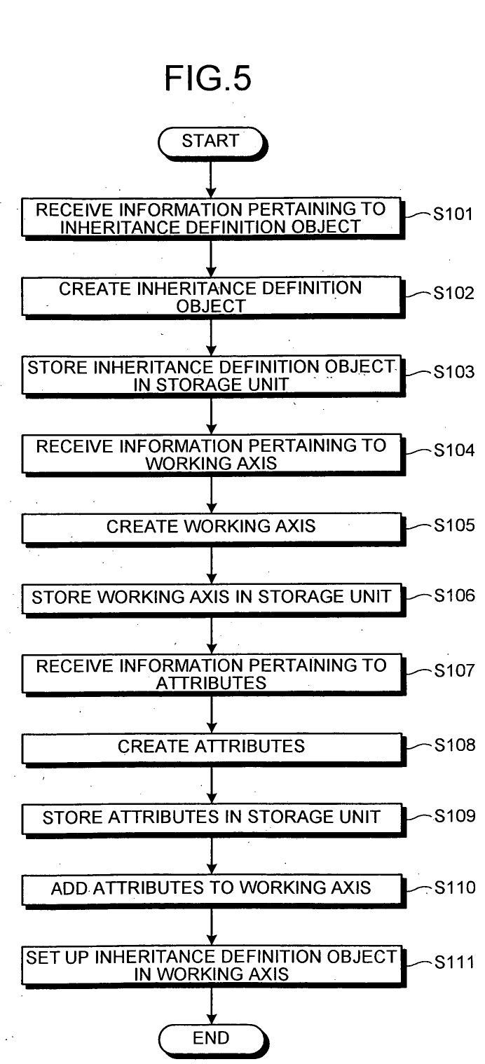

A process preceding shaft creation according to the first embodiment is explained next. FIG. 5 is a flowchart of the process preceding shaft creation. The inheritance definition object processor 110b receives from the input device 200 information pertaining to the inheritance definition object (Step S101), creates the inheritance definition object (Step S102), and stores the created inheritance definition object in the storage unit 120 (Step S103).

The shape creating/editing unit 110a receives from the input device 200 information pertaining to the working axis (Step S104), creates the working axis (Step S105), and stores the created working axis in the storage unit 120 (Step S106).

The attribute processor 110c receives from the input device 200 information pertaining to the attributes (Step S107), creates the attributes (Step S108), and stores the created attributes in the storage unit 120 (Step S109). The attribute processor 110c adds the attributes to the working axis (Step S110) and the inheritance definition object processor 110b sets up the inheritance definition object in the corresponding working axis (Step S111).

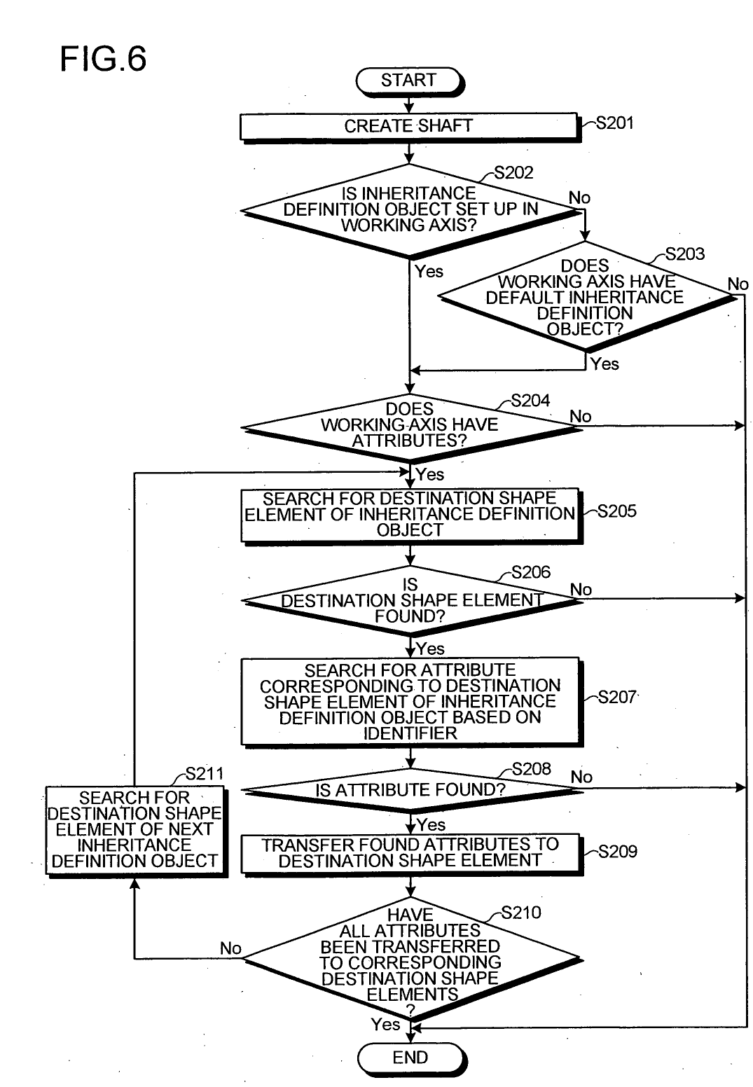

A shaft creation process of the shape element-attribute associator 110e is explained next. FIG. 6 is a flowchart of the shaft creation process. The shape creating/editing unit 110a creates the shaft (Step S201) and checks whether the inheritance definition object is set up in the working axis (Step S202).

If the inheritance definition object is not set up in the working axis (“No” at Step S202), the shape element-attribute associator 110e checks whether the working axis has a default inheritance definition object (Step S203). If the working axis has no default inheritance definition object (“No” at Step S203), the process ends there.

If the working axis has a default inheritance definition object (“Yes” at Step S203), the shape element-attribute associator 110e checks whether the working axis has attributes (Step S204). If the working axis has inheritance definition object (“Yes” at Step S202), the process proceeds directly to Step S204.

If the working axis has no attributes (“No” at Step S204), the process ends there. However, if the working axis has attributes (“Yes” at Step S204), the shape element-attribute associator 110e searches for a destination shape element of the inheritance definition object (the side face, the front face, etc. of the shaft in the first embodiment) (Step S205) and checks whether the destination shape element is found (Step S206).

If the destination shape element is not found (“No” at Step S206), the process ends there. However, if the destination shape element is found (“Yes” at Step S206), the shape element-attribute associator 110e searches for the attribute corresponding to the destination shape element of the inheritance definition object, based on the identifier (Step S207), and checks whether the attribute is found (Step S208).

If the attribute is not found (“No” at Step S208), the process ends there. However, if the attribute is found (“Yes” at Step S208), the shape element-attribute associator 110e transfers the found attribute to the destination shape element (Step S209) and checks whether all the attributes of the working axis have been transferred to their corresponding destination shape elements (Step S210).

If all the attributes of the working axis are not transferred to their corresponding destination shape elements (“No” at Step S210), the shape element-attribute associator 110e searches for the destination shape element of the next inheritance definition object (Step S211) and the process goes back to Step S205. However, if all the attributes of the working axis are transferred to their corresponding destination shape elements (“Yes” at Step S210), the process ends there.

To sum up, in the design aiding device 100 according to the first embodiment, the inheritance definition object processor 110b creates the inheritance definition object, the attribute processor 110c creates the attributes, and the created inheritance definition object and the attributes are added to the working axis created by the shape creating/editing unit 110a. When the shape creating/editing unit 110a creates the shaft from the working axis, the attributes are automatically transferred to the corresponding parts of the shaft. The shape element-attribute associator 110e automatically transfers, based on the inheritance definition object added to the working axis, the attributes to the corresponding part of the shaft in the initial stage as per the design intent of the designer, thereby mitigating the burden on the user.

The inheritance definition object obviates the need for managing information pertaining to the attributes to be transferred to the parts of the tangible shape for every reference element, thereby reducing the volume of data to be handled.

In the first embodiment, attributes were added to a reference element, and the attributes added to the reference element were transferred to corresponding parts of a tangible shape when the tangible shape was created from the reference element. However, it is possible to add the attributes, which are part of the design intent of a designer, to the tangible shape without adding the attributes to the reference element in advance. In other words, attributes can be passed on to the shaft even if they are not added to the working axis as in the first embodiment.

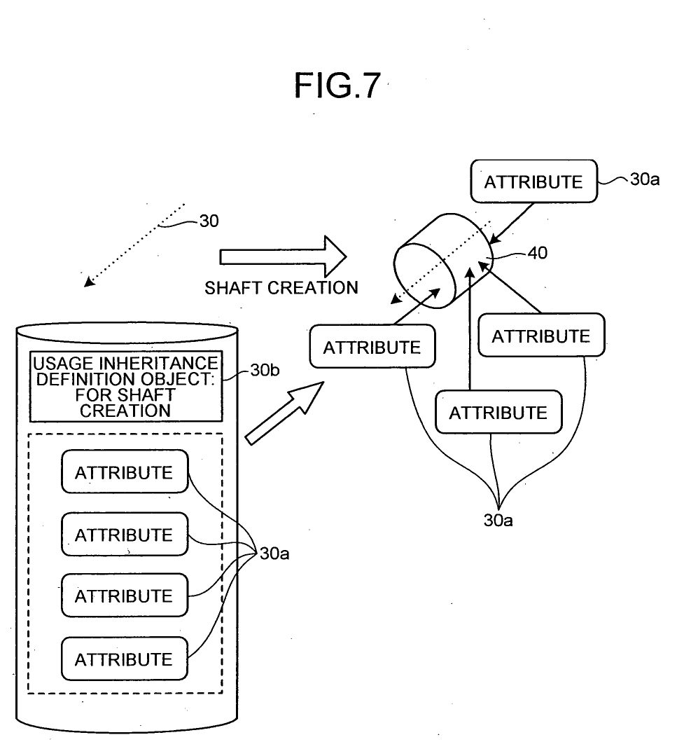

FIG. 7 is a concept drawing of design aiding according to a second embodiment of the present invention. Attributes 30a for a reference element 30 are stored in the storage unit 120 without being added to the reference element 30. A definition object (hereinafter, “usage inheritance definition object”), applied when a tangible shape 40 (a shaft in the second embodiment) is created from the reference element 30 (a working axis in the second embodiment) is created in advance.

In other words, the attributes are added to the corresponding parts of the created shaft using the usage inheritance definition object, which is applied when the shaft 40 is created from the working axis 30.

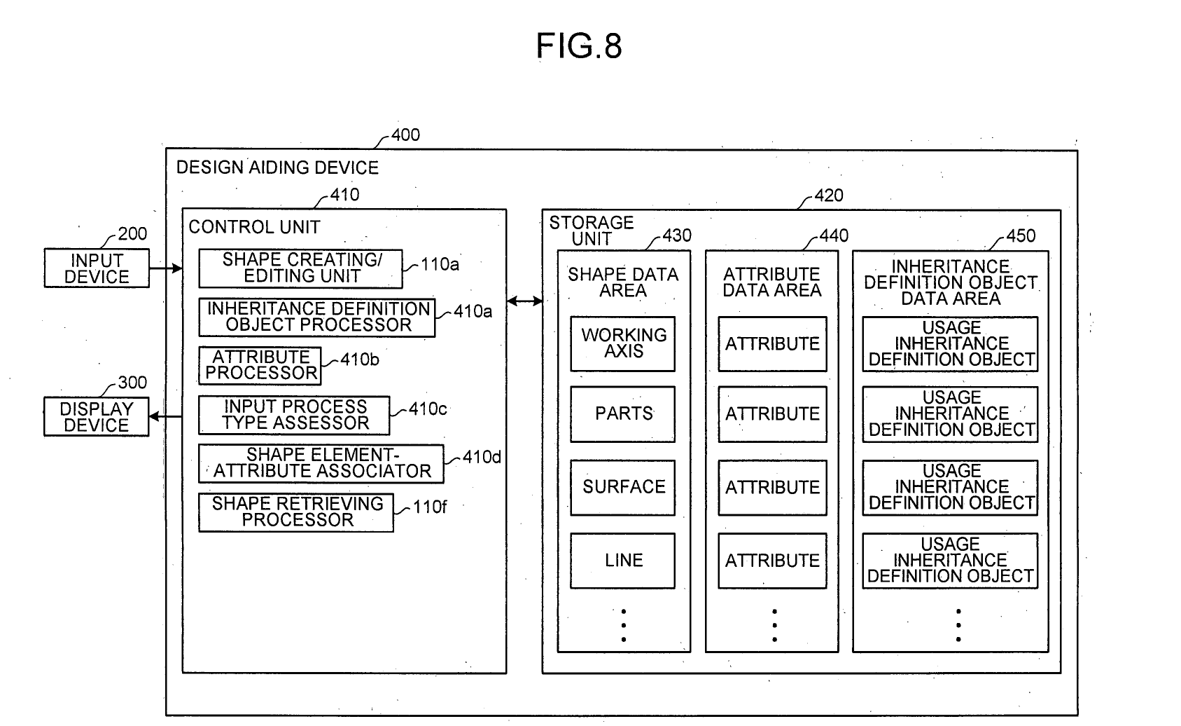

FIG. 8 is a functional block diagram of a design aiding device 400 according to the second embodiment. The design aiding device 400 includes a control unit 410 and a storage unit 420.

The control unit 410 includes an inheritance definition object processor 410a, an attribute processor 410b, an input process type assessor 410c, and a shape element-attribute associator 410d. Since the rest of the structure and functions of the design aiding device 400 is identical to those of the design aiding device 100 shown in the first embodiment, they are denoted by the same reference numerals and are not explained again.

The inheritance definition object processor 410a receives from the input device 200 information pertaining to the usage inheritance definition object, creates the usage inheritance definition object, and stores the created usage inheritance definition object in the storage unit 420.

The attribute processor 410b receives from the input device 200 information pertaining to the attributes, creates the attributes, and stores the created attributes in the storage unit 420.

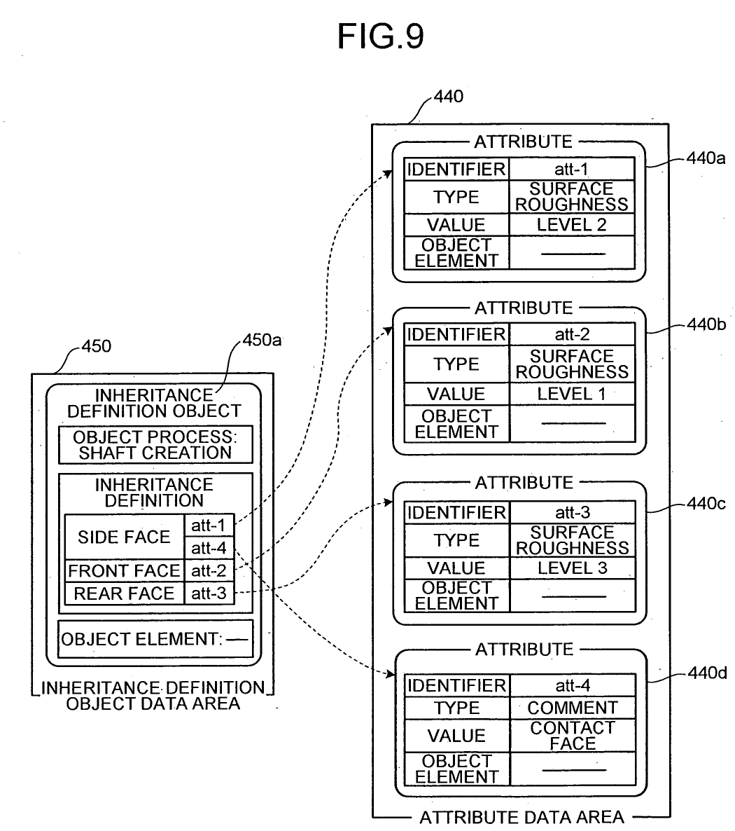

FIG. 9 is an example of the data structure of the usage inheritance definition object and the attributes before shaft creation according to the second embodiment. Identifiers correlate attributes 440a through 440d stored in an attribute data area 440 and a usage inheritance definition object 450a stored in an inheritance definition object data area 450. Unlike the first embodiment, the attribute 440a and the usage inheritance definition object 450a are not added to the geometric data of the working axis stored in a shape data area 430.

The input process type assessor 410c checks the information received from the input device 200. When the input process type assessor 410c assesses that the instruction to create the tangible shape is transferred to the shape creating/editing unit 110a, it notifies the fact to the shape element-attribute associator 410d. Information, such as which tangible shape is to be created from the reference element, is also transferred to the shape element-attribute associator 410d.

Upon receiving the information that the instruction to create a tangible shape has been transferred from the input process type assessor 410c to the shape creating/editing processor 110a and what tangible shape is to be created, the shape element-attribute associator 410d retrieves from the storage unit 420 the usage inheritance definition object corresponding to the created tangible shape.

Based on the usage inheritance definition object, the shape element-attribute associator 410d transfers the attributes to the corresponding parts of the created shape. To be more specific, in the second embodiment, since the shaft 40 is created as the tangible shape, the shape element-attribute associator 410d transfers, based on the usage definition object 450a that corresponds to the shaft creation, the attributes 440a and 440d to the side face of the shaft 40, the attribute 440b to the front face of the shaft 40, and the attribute 440c to the rear face of the shaft 40.

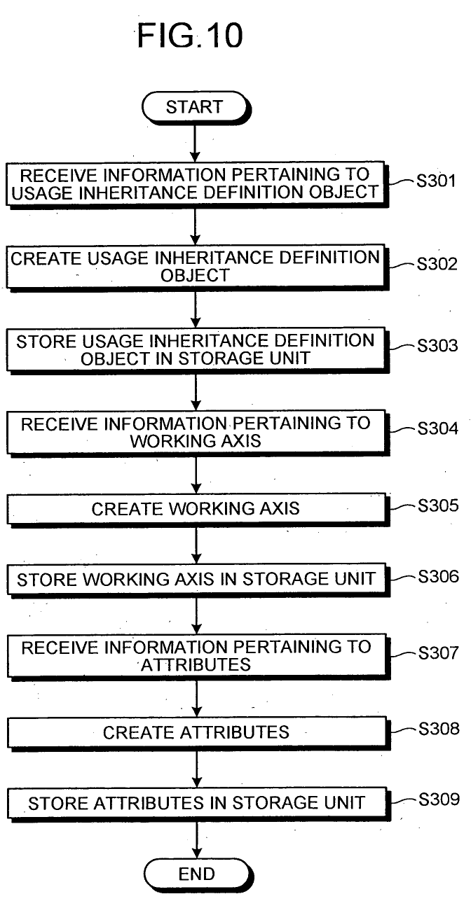

A process preceding shaft creation according to the second embodiment is explained next. FIG. 10 is a flowchart of the process preceding shaft creation. The inheritance definition object processor 410a receives from the input device 200 information pertaining to the usage inheritance definition object (Step S301), creates the usage inheritance definition object (Step S302), and stores the created usage inheritance definition object in the storage unit 420 (Step S303).

The shape creating/editing unit 110a receives from the input device 200 information pertaining to the working axis (Step S304), creates the working axis (Step S305), and stores the created working axis in the storage unit 420 (Step S306).

The attribute processor 410b receives information pertaining to the attributes (Step S307), creates the attributes (Step S308), and stores the created attributes in the storage unit 420 (Step S309).

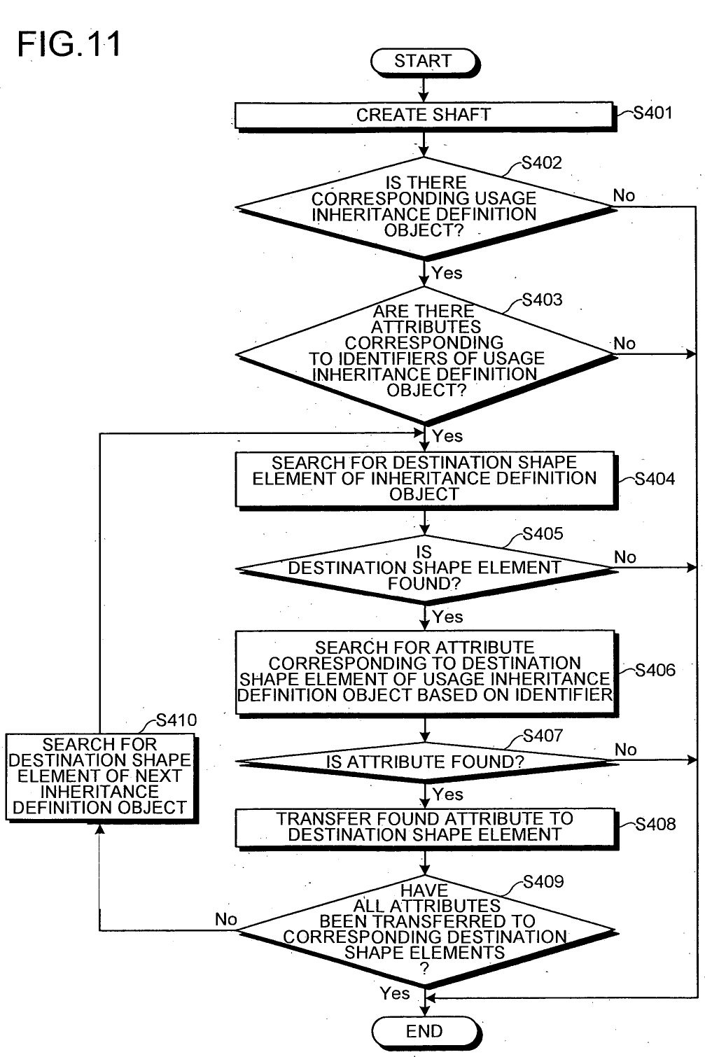

A shaft creation process according to the second embodiment is explained next. FIG. 11 is a flowchart of the shaft creation process. The shape creating/editing unit 110a creates the shaft (Step S401) and the shape element-attribute associator 410d checks whether there is a corresponding usage inheritance definition object (Step S402). If there is no corresponding usage inheritance definition object (“No” at Step S402), the process ends there.

However, if there is a corresponding usage inheritance definition object (“Yes” at Step S402), the shape element-attribute associator 410d checks whether there are attributes corresponding to the identifiers of the usage inheritance definition object (Step S403). If there are no attributes corresponding to the identifiers of the usage inheritance definition object (“No” at Step 403), the process ends there.

If there are attributes corresponding to the identifiers of the usage inheritance definition object (“Yes” at Step S403), the shape element-attribute associator 410d searches for the destination shape element of the usage inheritance definition object (Step S404) and checks whether the destination shape element is found (Step S405).

If the destination shape element is not found (“No” at Step S405), the process ends there. However, if the destination shape element is found (“Yes” at Step S405), the shape element-attribute associator 410d searches for the attribute corresponding to the destination shape element of the usage inheritance definition, based on the identifier (Step S406), and checks whether the attribute is found (Step S407).

If the attribute is not found (“No” at Step S407), the process ends there. However, if the attribute is found (“Yes” at Step S407), the shape element-attribute associator 410d transfers the found attribute to the corresponding destination shape element (Step S408) and checks whether the all the attributes have been transferred to their corresponding destination shape elements (Step S409).

If all the attributes are transferred to their corresponding destination shape elements (“Yes” at Step S409), the process ends there. However, if all the attributes are not transferred to their corresponding destination shape elements (“No” at Step S409), the shape element-attribute associator 410d searches for the destination shape element of the next usage inheritance definition object (Step S410) and the process goes back to Step S404.

To sum up, in the design aiding device 400 according to the second embodiment, when the shape creating/editing unit 110a creates the shaft, the shape element-attribute associator 410d uses the usage inheritance definition object corresponding to the shaft to transfer the attributes to the corresponding parts of the created shaft. This ensures efficient creation of shaft according to the design intent of the designer.

A design aiding device is explained in the first and the second embodiment. However, a structure that performs all the functions of the design aiding device may be realized by means of a computer program. A computer system that executes such a computer program is explained next.

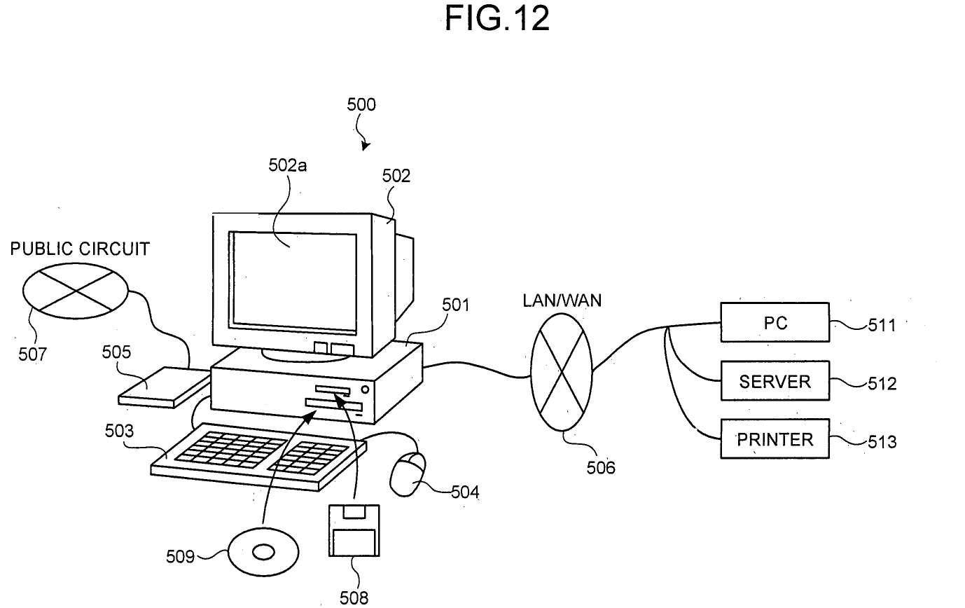

FIG. 12 is a computer system 500 that executes the computer program according to another embodiment of the present invention. The computer system 500 includes a main unit 501, a display 502 that displays the information on a display screen 502a based on the instructions from the main unit 501, a keyboard 503 that enters various information into the computer system 500, a mouse 504 that points to a position on the display screen 502a of the display 502, a local area network (LAN) interface that is connected to a LAN 506 or a wide area network (WAN), and a modem 505 that is connected to a public circuit 507. The LAN 506 connects another computer system (PC) 511, a server 512, and a printer 513 to the computer system 500.

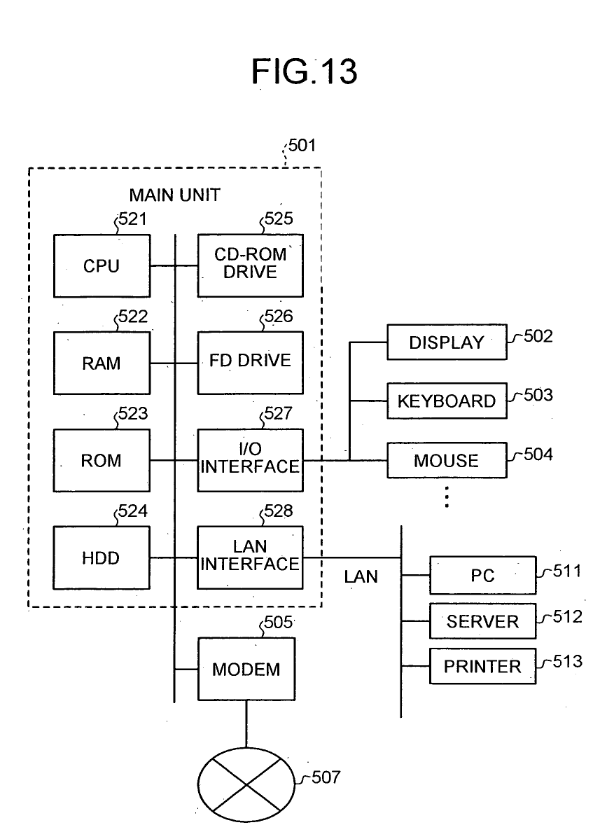

FIG. 13 is a functional block diagram of the main unit 501. The main unit 501 includes a central processing unit (CPU) 521, a random access memory (RAM) 522, a read-only memory (ROM) 523, a hard disk drive (HDD) 524, a compact disk-read-only memory (CD-ROM) 525, a floppy disk drive (FD drive) 526, an input/output interface (I/O interface) 527, and a LAN interface 528.

The computer program executed by the computer system 500 is stored in a removable recording medium such as a floppy disk (FD) 508, a compact disk-read-only memory (CD-ROM) 509, a digital versatile disk (DVD), an optical disk, an integrated circuit card (IC card), and the like, loaded from the recording medium, and installed on the computer system 500. The installed motion distribution program is stored in the HDD 524 and is executed by the CPU 521 with the aid of the RAM 522 and the ROM 523.

To sum up, according to the present invention, information pertaining to attributes of a reference element, which is an element of a part in the initial stage of a top-down designing, and identification information that identifies the attributes, are obtained along with a definition object that has, in a correlated form, each of the plural elements constituting a shape element and its identification information, the shape element being a tangible form of the reference element. Based on the definition object, the attributes are passed on to the corresponding elements of the tangible shape element. Consequently, a design intent of a designer in the course of designing is automatically passed on to the tangible shape element.

Moreover, when no definition object is added to the reference element, which is an element of a part in the initial stage of a top-down designing, a default definition object corresponding to a tangible shape element is obtained from a storage device. Based on the default definition object, the attributes are passed on to the corresponding elements of the tangible shape element. Consequently, the burden on a user can be reduced and parts can be created efficiently.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A computer program that contains instructions which when executed on a computer cause the computer to perform:
obtaining an attribute and identification information that identifies the attribute, and a definition object that has in a correlated form each of a plural elements constituting a tangible shape element and the identification information of the tangible shape element, that are added to a reference element; and
passing on the attribute obtained to a relevant element of the tangible shape element,
wherein the reference element is an element of a part in an initial stage in a top-down approach, and the tangible shape element is a tangible form of the reference element.

2. The computer program according to claim 1, wherein the attribute includes information pertaining to a type of the attribute and a value of the attribute.

3. The computer program according to claim 1, wherein the obtaining includes obtaining from a storage device a default definition body corresponding to the tangible shape element, if no definition object is added to the reference element.

4. A computer program that contains instructions which when executed on a computer cause the computer to perform:
obtaining from a storage device an attribute and identification information that identifies the attribute, and a definition object that has in a correlated form each of a plural elements constituting a tangible shape element and the identification information of the tangible shape element, that are added to a reference element; and
passing on the attribute obtained to a relevant element of the tangible shape element,
wherein the reference element is an element of the part in an initial stage in the top-down approach, and the tangible shape element is a tangible form of the reference element.

5. A design aiding method comprising:
obtaining an attribute and identification information that identifies the attribute, and a definition object that has in a correlated form each of a plural elements constituting a tangible shape element and the identification information of the tangible shape element, that are added to a reference element; and
passing on the attribute obtained to a relevant element of the tangible shape element,
wherein the reference element is an element of a part in an initial stage in a top-down approach, and the tangible shape element is a tangible form of the reference element.

6. The design aiding method according to claim 5, wherein the obtaining includes obtaining from a storage device a default definition body corresponding to the tangible shape element, if no definition object is added to the reference element.

7. A computer-readable recording medium that stores a computer program that contains instructions which when executed on a computer cause the computer to perform:
obtaining an attribute and identification information that identifies the attribute, and a definition object that has in a correlated form each of a plural elements constituting a tangible shape element and the identification information of the tangible shape element, that are added to a reference element; and
passing on the attribute obtained to a relevant element of the tangible shape element,
wherein the reference element is an element of a part in an initial stage in a top-down approach, and the tangible shape element is a tangible form of the reference element.

8. A design aiding apparatus comprising:
an obtaining unit that obtains an attribute and identification information that identifies the attribute, and a definition object that has in a correlated form each of a plural elements constituting a tangible shape element and the identification information of the tangible shape element, that are added to a reference element; and
a passing unit that passes on the attribute obtained to a relevant element of the tangible shape element,
wherein the reference element is an element of a part in an initial stage in a top-down approach, and the tangible shape element is a tangible form of the reference element.
